(19) United States
(12) Patent Application Publication
(10) Pub. No.: US 2024/0103224 A1
(43) Pub. Date: Mar. 28, 2024

(54) Optical Splitters with Reflective Surfaces

(71) Applicant: Apple Inc., Cupertino, CA (US)

(72) Inventors: Mark A. Arbore, Los Altos, CA (US); Jason S. Pelc, Sunnyvale, CA (US)

(21) Appl. No.: 18/230,475

(22) Filed: Aug. 4, 2023

Related U.S. Application Data
(60) Provisional application No. 63/409,603, filed on Sep. 23, 2022.

(51) Int. Cl. G02B 6/28

(52) U.S. Cl. CPC G02B 6/2817

(57) ABSTRACT

Configurations for an optical splitter that includes a continuous curved reflector and methods thereof are disclosed. The optical splitter includes an input waveguide, one or more continuous curved reflector, and multiple output waveguides. The one or more continuous curved reflector may direct light toward the output waveguides. The optical splitter may include a single continuous curved reflector, or may include multiple continuous curved reflectors. In other instances, an optical splitter may include a lensed reflector that includes a plurality of continuous curved segments.

### CROSS-REFERENCE TO RELATED APPLICATION

This application is a nonprovisional and claims the benefit under 35 U.S.C. 119(e) of U.S. Provisional Patent Application No. 63/409,603, filed Sep. 23, 2022, the contents of which are incorporated herein by reference as if fully disclosed herein.

### FIELD

This disclosure relates generally to optical splitters, and systems and methods that utilize these optical splitters. More particularly, this disclosure relates to optical splitters that have reflective surfaces that redirect light between an input waveguide and a plurality of output waveguides

### BACKGROUND

Optical splitters are often used in a photonic integrated circuit to split or combine light. For example, an optical splitter may split light received from an input into multiple outputs (or combine light from multiple inputs to a single output if operated in reverse). Optical splitters typically increase in size and/or complexity as the number of outputs increases, as it becomes more difficult to evenly split light between outputs while maintaining a small form factor and low optical losses. This is further complicated as the target bandwidth of the splitter (i.e., the range of wavelengths across which the optical splitter is expected to perform) increases. Since space is at a premium in many devices, an optical splitter may place significant size constraints on a photonics integrated circuit depending on the number of outputs and performance requirements of the optical splitter. It may thus be desirable to provide compact optical splitters with low optical losses.

### SUMMARY

Embodiments described in the present disclosure are directed to optical splitters that include reflective surfaces, as well as photonic integrated circuits and optical systems that include these optical splitters and methods of splitting light using the optical splitters. Some embodiments are directed to an optical splitter that includes an input waveguide, free propagation region optically coupled to the input waveguide, a continuous curved reflector positioned to receive and redirect a beam of input light introduced into the free propagation region from the input waveguide, and a plurality of output waveguides optically coupled to the free propagation region. Each output waveguide of the plurality of output waveguides includes an output portion connected to the free propagation region and positioned to receive a corresponding portion of the beam of input light redirected by the continuous curved reflector.

In some variations, a width of each output portion of each output waveguide of the plurality of output waveguides is substantially the same. Additionally or alternatively, the output portions of each of the plurality of output waveguides are parallel to each other. In some instances, the continuous curved reflector has an intermediate portion positioned between a first peripheral portion and a second peripheral portion, wherein a radius of curvature of the continuous curved reflector is larger in the intermediate portion than in the first peripheral portion and the second peripheral portion. In some variations, the output portions of each of the plurality of output waveguides are connected to the free propagation region along a straight line. In other variations, the output portions of each of the plurality of output waveguides are connected to the free propagation region along a curve.

Additionally or alternatively, the continuous curved reflector is decentered and/or tilted relative to the input waveguide, such that the continuous curved reflector is positioned to redirect the beam of input light away from the input waveguide. Additionally or alternatively, the continuous curved reflect is positioned to focus the beam of input light toward the plurality of output waveguides.

Other embodiments are directed to an optical splitter that includes an input waveguide a slab waveguide optically coupled to the input waveguide, a first continuous curved reflector positioned to form a first boundary of the slab waveguide and positioned to receive and redirect a beam of input light received from the input waveguide, and a second continuous curved reflector positioned to form a second boundary of the slab waveguide and positioned to receive and redirect the beam of input light redirected from the first continuous curved reflector. The optical splitter also includes a plurality of output waveguides optically coupled to the slab waveguide, wherein each output waveguide of the plurality of output waveguides includes an output portion connected to the slab waveguide along a third boundary of the slab waveguide and positioned to receive a corresponding portion of the beam of input light redirected by the second continuous curved reflector. In some instance, the third boundary of the of the slab waveguide is a straight line.

In some variations, the first continuous curved reflector has an aspheric profile. Additionally or alternatively, the second continuous curved reflector has an aspheric profile. In some instances, the first continuous curved reflector is decentered and/or tilted relative to the input waveguide, such that the first continuous curved reflector is positioned to redirect the beam of input light away from the input waveguide. Additionally or alternatively, the second continuous curved reflector is decentered and/or tilted relative to the first continuous curved reflector, such that the second continuous curved reflector is positioned to redirect the beam of input light away from the first continuous curved reflector.

In some instances, the width of each output portion of each output waveguide of the plurality of output waveguides is substantially the same. Additionally or alternatively, the output portions of each of the plurality of output waveguides are parallel to each other. Additionally or alternatively, the first continuous curved reflector and the second continuous curved reflector are positioned and shaped to collimate the beam of input light in a direction toward the third boundary of the slab waveguide.

Still other embodiments are directed to an optical splitter configured to split an input beam of light, and that includes an input waveguide, a free propagation region optically coupled to the input waveguide and positioned to receive the beam of input light from the input waveguide, and a lensed reflector positioned to receive the input beam of light introduced into the free propagation region and divide the input beam into a plurality of output beams of light. The optical splitter also includes a plurality of output waveguides optically coupled to the free propagation region. The lensed reflector comprises a plurality of continuous curved segments, where each continuous curved segment of the plurality of continuous curved segments is configured to receive a corresponding portion of the input beam of light and redirect the corresponding portion of the input beam of light to generate an output beam of light of the plurality of output beams of light, such that the continuous curved segment directs light to a corresponding output waveguide of the plurality of output waveguides.

In some variations, ach output waveguide of the plurality of output waveguides comprises an output portion connected to the free propagation region. The width of each output portion of each output waveguide of the plurality of output waveguides may be substantially the same. Additionally or alternatively, the output portions of each of the plurality of output waveguides are parallel to each other. In other variations, the output portions of each of the plurality of output waveguides are non-parallel to each other.

In some variations, the plurality of output waveguides is positioned such that the plurality of output beams of light cross within the free propagation region before reaching the plurality of output waveguides. Additionally or alternatively, each continuous curved segment of the plurality of continuous curved segments has an ellipsoidal shape. Additionally or alternatively, the lensed reflector is configured such that the output beam generated by each continuous curved segment of the plurality of continuous curved segments has substantially the same optical power.

In addition to the example aspects and embodiments described above, further aspects and embodiments will become apparent by reference to the drawings and by study of the following description.

### BRIEF DESCRIPTION OF THE DRAWINGS

FIG. 1 illustrates an example of an optical splitter configured as a star coupler.

FIGS. 2 and 3 depict top views of variations of optical splitters as described herein that include continuous reflectors.

FIGS. 4 and 5 depict top view of variations of optical splitters as described herein that include lensed reflectors.

FIG. 6 illustrates an example of an optical system that incorporates an optical splitter as described herein.

It should be understood that the proportions and dimensions (either relative or absolute) of the various features and elements (and collections and groupings thereof) and the boundaries, separations, and positional relationships presented between them, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

Disclosed herein are optical splitters that utilize reflectors having continuous curves to route between an input waveguide and a plurality of output waveguides. Specifically, the reflectors are positioned to redirect a beam of light received from an input waveguide and may adjust characteristics of this beam of light as it reaches the plurality of output waveguides. This may improve the uniformity of intensity of light that reaches the plurality of output waveguides and may improve the optical efficiency of light coupling into the plurality of output waveguides. In some instances, the optical splitters described herein may include a single continuous reflector or a plurality of continuous reflectors. In other embodiments, the optical splitters described herein include a lensed reflector that includes multiple continuous curved segments.

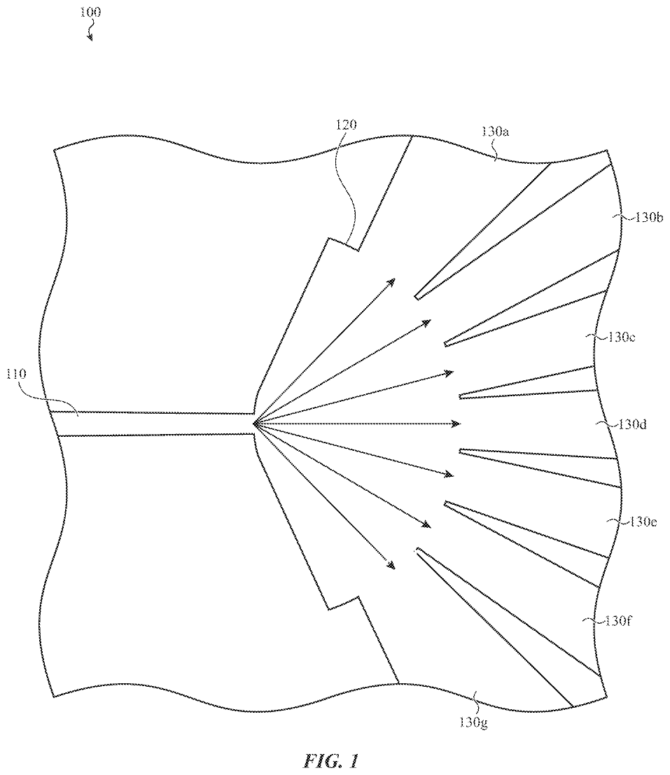

These and other embodiments are discussed below with reference to FIGS. 1-6. However, those skilled in the art will readily appreciate that the detailed description given herein with respect to these Figures is for explanatory purposes only and should not be construed as limiting.

As used herein, a “continuous curve” refers to a curve that has a single tangent line at each point of the curve. Similarly, as used herein, a “continuous curved” component (e.g., a continuous curved reflector or a continuous curved segment of a reflector) refers to a component that is shaped to have a continuous curve without inflection points. Accordingly, a continuous curved reflector or a continuous curved segment of a reflector as described herein may act as a curved reflecting surface that is either entirely concave or entirely convex. In this way, a continuous curved reflector or segment provides a “smooth” reflecting surface free of periodic teeth, facets, or other groove structures that would cause incident light on the reflector to diffract.

It should be appreciated that when a continuous curved reflector (or a continuous curved segment of a reflector) is described herein as redirecting a beam of light (or a portion thereof), it should be appreciated that only the portion of the reflector that receives this beam of light need be shaped as a continuous curve without inflection points. Other portions of the reflector that do not receive the beam of light may have any shape (e.g., with inflection points or discontinuities) as these portions of the reflector may not impact the splitting operation of the optical splitters as described herein.

As used herein, two elements that are “connected” are in direct physical contact with each other. Two elements that are “optically coupled” are positioned relative to each other such that light may pass from one element to the other element. Two elements may be optically coupled without being connected, such as when light passes through an intervening element to pass from one element to the other element.

In some instances of known optical splitters, a star coupler is used to split light. FIG. 1 illustrates one such example of a star coupler 100. The star coupler 100 includes an input waveguide 110, a free propagation region 120 and a plurality of output waveguides 130a-130g. The input waveguide 110 and the plurality of output waveguides 130a-130g are each connected to the free propagation region 120. Specifically, the input waveguide 110 is optically connected to the free propagation region 120 such that the free propagation region 120 may receive a beam of input light from the input waveguide 110. The beam of input light diffracts as it enters the free propagation region 120, causing the beam of light to diverge as it travels in the free propagation region 120. The plurality of output waveguides 130a-130g are positioned such that a corresponding portion of the beam of input light couples into each of the plurality of output waveguides 130a-130g. Accordingly, the beam of input light is split between the plurality of output waveguides 130a-130g.

The intensity of the diffracting light within the free propagation region 120 is not uniform, and light at a periphery of the beam of light traveling through free propagation region 120 (e.g., light propagating toward output waveguides 130a and 130g) is less intense than light at the center of the beam (e.g., light propagating along the path of the input waveguide 110). In instances where it is desirable to evenly split the input light between the plurality of output waveguides 130a-130g, the width of the output waveguides 130a-130g are varied such that the width of the waveguides increases toward the periphery of the free propagation region 120. For example, as shown in FIG. 1, the output waveguides in the periphery (e.g., output waveguides 130a and 130g) are each wider than the central output waveguides (e.g., output waveguide 130d).

Increasing the width of certain waveguides may improve the distribution of light between the output waveguides of the star coupler 100, but may increase coupling losses as light couples from the free propagation region 120 to a given output waveguide. Typically the plurality of output waveguides 130a-130g are connected to the free propagation region 120 along a circular arc (e.g., a Rowland circle), which may facilitate each of the plurality of output waveguides 130a-130g being positioned perpendicular to the phase front of the beam of input light. There will be some insertion loss as the beam of input light changes from a curved phase front in the free propagation region 120 to a flat phase front in each of the output waveguides 130a-130g, and this loss increases as a function of the respective widths of the plurality of output waveguides 130a-130g. Additionally, the wider waveguides will experience a larger variation in the illumination intensity across the width of the waveguide. Overall, there will be larger insertion losses for the wider output waveguides in the periphery (e.g., output waveguides 130a and 130g) than for the central output waveguide (e.g., output waveguide 130d).

Accordingly, a star coupler, such as illustrated in FIG. 1, may provide for relatively even splitting of the input light at the cost of increased optical losses. Further, in instances where it is desirable for the optical splitter to have equal output waveguide widths, at least some of the output waveguides will taper as they move away from the free propagation region 120 to achieve the same width as other output waveguides. The space needed for the output waveguides to taper (especially when adiabatic tapering is used to avoid changing the mode of light within an output waveguide) can significantly increase the size of the star coupler 100, especially as the number of output waveguides increases.

Conversely, the optical splitters described herein utilize reflectors to change the shape and intensity distribution of the beam of input light, which may split light with reduced insertion losses when compared to star couplers having the same number of output waveguides. Additionally, the optical splitters described herein may achieve this splitting in a smaller form factor that similarly-configured star couplers.

The optical splitters described herein may be formed in a waveguide layer of a photonic integrated circuit. The photonic integrate circuit includes a planar substrate, a lower cladding layer supported (directly or indirectly) by the substrate, and a waveguide layer positioned on the cladding layer. The waveguide layer may be etched or patterned to create cavities that define the boundaries of the optical splitter (e.g., an input waveguide, a slab waveguide forming a free propagation region, and a plurality of output waveguides). These cavities may be filled with an additional cladding material or left unfilled to provide an air interface, which may provide optical confinement to components of the optical splitter within a plane of the waveguide layer. In some instances, an upper cladding layer (which may be the same as or different than the cladding material filling cavities formed in the waveguide layer) may further be positioned on a top surface of the waveguide layer, such that the upper and lower cladding layers collectively act to confine light within the plane of the waveguide layer. In other instances, an air interface with a top surface of the waveguide layer (or a portion thereof) may provide optical confinement to the waveguide layer.

The various layers of the photonic integrated circuits described herein may be formed from any suitable material(s) depending on the wavelength or wavelengths of light that will be carried by the waveguides defined in the photonic integrated circuit. For example, in some variations, the waveguide layer (and thereby any waveguide core) is formed from silicon, silicon nitride, silica, or the like, the cladding layer (or layers) is formed from a dielectric material (or materials) such as silicon dioxide, and the substrate is formed from silicon.

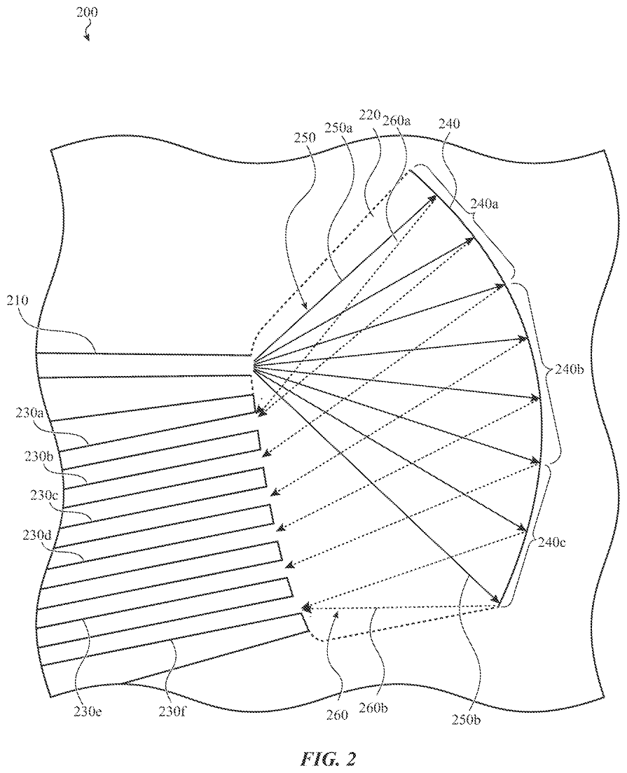

In some variations, the optical splitters described herein include a continuous curved reflector that is positioned to receive and redirect a beam of input light. FIG. 2 depicts a top view of an example of an optical splitter 200 with a continuous curved reflector 240. The optical splitter 200 includes an input waveguide 210, a free propagation region 220, the continuous curved reflector 240 and a plurality of output waveguides 230a-230f. The optical splitter 200 is configured such that the input waveguide 210 introduces a beam of input light 250 into the free propagation region 220 that is received and redirected by the continuous curved reflector 240 in a direction toward the plurality of output waveguides 230a-230f. In this way, the optical splitter 200 may split input light received from the input waveguide 210 between the plurality of output waveguides 230a-230f.

Specifically, an input portion of the input waveguide 210 is connected to the free propagation region 220 to optically couple the input waveguide 210 to the free propagation region 220. The input portion of the input waveguide 210 terminates at a slab waveguide, where a portion of the slab waveguide acts as the free propagation region 220. The input waveguide 210 may receive light (e.g., from a light source unit as described herein) and emit a beam of input light 250 into the free propagation region 220.

Light emitted from the input waveguide 210 will diffract as it enters the slab waveguide, which results in the beam size of the beam of input light 250 increasing as it traverses the free propagation region 220. The slab waveguide is sized such that the beam of input light 250 may freely propagate within the free propagation region 220 between the input waveguide and the continuous curved reflector 240, and between the continuous curved reflector 240 and the plurality of output waveguides 230a-230f. While dashed lines are used in FIG. 2 to illustrate certain boundaries of the free propagation region 220 (i.e., within a waveguide layer), it should be appreciated that the actual boundaries (if any) between the slab waveguide and surrounding cladding material (or air interfaces) may be positioned in any manner that will not impair the operation of the optical splitter 200.

The angle of diffraction for the beam of input light 250 depends on the ratio between the wavelength and the mode size of the input light as it reaches the slab waveguide, which can result in different diffraction angles for different wavelengths of input light. This in turn may cause the beam size of the beam of input light 250 to vary as a function of wavelength, which may result in wavelength-dependent variations in performance of the optical splitter. To help reduce this wavelength dependency, a width of the input waveguide 210 (i.e., in the plane of the waveguide layer defining the input waveguide 210) may optionally be sized to be sufficiently narrow (e.g., via tapering) as it approaches the free propagation region 220, such that the size of the mode of the input light becomes proportional to the wavelength of the input light across the predetermined target range of wavelengths. In these instances, certain wavelengths of light traveling in the input waveguide 210 will be weakly confined in the input waveguide 210 (i.e., within the plane of the waveguide layer defining the input waveguide 210), thus generating the appropriate mode size. This in turn may improve the uniformity of the diffraction angle as a function of wavelength. Accordingly, when the optical splitter 200 is intended to operate over a target range of wavelengths, the width of the input portion of the input waveguide 210 may be chosen based on this target range of wavelengths to reduce wavelength-dependent variations in the diffraction angle across the target range of wavelengths. In some of these variations, the input portion of the input waveguide 210 may be tapered (e.g., adiabatically) to reduce the width of the input waveguide 210 in order to improve the performance of the optical splitter 200 across a target range of wavelengths.

The continuous curved reflector 240 forms a first boundary of the slab waveguide, and thereby forms a first boundary of the free propagation region 220. The continuous curved reflector 240 is sized and positioned to receive and redirect the beam of input light 250 toward the plurality of output waveguides. The redirected light is depicted in FIG. 2 as a beam of redirected light 260. The beam of input light 250 is depicted in FIG. 2 by a set of rays between outermost rays 250a and 250b, though it should be appreciated that the beam of input light 250 fills the entire space between the outermost rays 250a and 250b. Similarly, the beam of redirected light 260 is depicted in FIG. 2 by a set of dashed rays between outermost rays 260a and 260b, though it should be appreciated that the beam of redirected light 260 fills the entire space between the outermost rays 260a and 260b.

The continuous curved reflector 240 acts as a reflector to reflect the beam of input light 250. To form the continuous curved reflector 240, a waveguide layer defining the slab waveguide may be etched or otherwise patterned to expose a vertical surface of the slab waveguide (i.e., that is perpendicular to the plane of the waveguide layer). The vertical surface may be coated with an additional material such as a metal, such that the interface between the slab waveguide and the additional material acts to reflect light that is incident on the vertical surface. Accordingly, the vertical surface of the slab waveguide defines the continuous curved reflector 240.

In some variations, the continuous curved reflector 240 has a profile that is decentered and/or tilted with respect to the input waveguide 210, such that the beam of input light 250 is redirected away from the input waveguide 210. In other words, a decentered and/or tilted continuous curved reflector 240 may redirect the beam of input light 250 such that the beam of redirected light 260 does not overlap with the input waveguide 210 (and thus, light is not coupled back into the input waveguide 210).

Additionally, the continuous curved reflector 240 has a profile that focuses the beam of input light 250 toward the output waveguides. This may focus the beam of redirected light 260 toward the plurality of output waveguides 230a-230f. In other words, the beam size of the beam of redirected light 260 is larger at the continuous curved reflector 240 than at the plurality of output waveguides. For example, the continuous curved reflector 240 may have a cylindrical profile, a cylindrical+conic profile, a cylindrical+asphere profile, or the like.

In some instances, the continuous curved reflector 240 has a profile designed to improve the uniformity of intensity across the beam of input light. For example, in some variations the continuous curved reflector 240 may have an aspherical profile that is configured such that radius of curvature of the continuous curved reflector 240 varies across the continuous curved reflector 240. Specifically, the continuous curved reflector 240 may be configured such that the radius of curvature is larger in an intermediate portion of the continuous curved reflector 240 than in peripheral portions of the continuous curved reflector 240.

For example, in the variation of the continuous curved reflector 240 shown in FIG. 2, the continuous curved reflector 240 includes a first peripheral portion 240a, an intermediate portion 240b, and a second peripheral portion 240c. The intermediate portion 240b is positioned between the first and second peripheral portions 240a, 240c, and the radius of curvature of the continuous curved reflector 240 is larger in the intermediate portion 240b than in the first and second peripheral portions 240a, 240c. It should be appreciated that the radius of curvature of the continuous curved reflector 240 may vary within each portion of the continuous curved reflector 240, and in these instances the entire range of values of the radius of curvature in the intermediate portion 240b may be larger than the entire ranges of values of the radius curvature in the first and second peripheral portions 240a, 240c.

Because the radius of curvature of the continuous curved reflector 240 is smaller in the first and second peripheral portions 240a, 240c, the first and second peripheral portions 240a, 240c will have a stronger focusing effect than the intermediate portion 240b. As a result, the peripheral portions of the beam of input light 250 will be focused to a relatively smaller area as compared to the central portion of the beam of input light 250, which will increase the relative intensity of the peripheral portions of the beam of redirected light 260 as compared to the central portion. Since the average intensity is smaller in the peripheral portions of the beam of input light 250 than in the central portion of the beam of input light 250, the stronger focusing provided by the first and second peripheral portions 240a, 240c may act to increase the uniformity of the beam of redirected light 260 (as compared to the beam of input light 250 as it reaches the plurality of output waveguides. Accordingly, the profile of the continuous curved reflector 240 may be selected to achieve a particular intensity distribution at the plurality of output waveguides 230a-230f. While the continuous curved reflector 240 is configured in FIG. 2 to improve the uniformity of intensity across the beam of redirected light 260 relative to the beam of input light 250, in other instance the continuous curved reflector 240 may be configured to intentionally vary the intensity across the beam of redirected light 260. Specifically, in instances where it is desirably to unevenly split light between the output waveguides 230a-230f, the continuous curved reflector 240 may determine the relative intensity receive by each of the output waveguides 230a-230f.

When the beam of redirected light 260 has a more uniform intensity distribution, the plurality of output waveguides 230a-230f may similarly be configured to have a more uniform distribution of widths while still evenly splitting light between the output waveguides. Specifically, each output waveguide of the plurality of output waveguides 230a-230f includes an output portion that is connected to the slab waveguide (and thereby to the free propagation region 220) to optically couple the output waveguide to the free propagation region 220. In some instances a width of the output portion of each of the plurality of output waveguides 230a-230f is substantially the same. For purposes of this application, two or more waveguides are considered to have “substantially the same” width if the values of the widths of these waveguides are within 20% of each other. It should be appreciated that in some instances an optical splitter may be designed with less variation between the output waveguides 230a-230f at their corresponding output portions. For example, in some variations the plurality of output waveguides 230a-230f have corresponding widths at their respective output portions with values that are within 10% of each other.

Accordingly, depending on the size and intensity distribution of the beam of redirected light 260 when it reaches the plurality of output waveguides 230a-230f, the optical splitter 200 may be configured with output portions of the output waveguides 230a-230f that have substantially the same width while still evenly splitting the beam of input light 250 between the plurality of output waveguides 230a-230f. The more uniform waveguide widths improve insertion losses as light couples into the plurality of output waveguides 230a-230f, which may improve splitting performance when compared to conventional star couplers having the same number of output waveguides. Additionally, the optical splitter 200 may also save space by virtue of the output waveguides 230a-230f having substantially the same width at their corresponding output portions, as it may not be necessary to taper the output waveguides 230a-230f to achieve a common waveguide size (though some level of tapering may still occur if desired).

The positioning and orientation of the output waveguides 230a-230f relative to the free propagation region may be selected to further reduce insertion losses associated with light coupling from the free propagation region 220 into the plurality of output waveguides 230a-230f. For example, the output waveguides 230a-230f may be connected to the slab waveguide (and thereby the free propagation region 220) along a line. In other words, the point at which each the output portion of each output waveguide 230a-230f terminates at the slab waveguide may be positioned along a line, which forms a portion of the boundary of the slab waveguide. In some variations, the line is a straight line, such that the plurality of output waveguide is connected to slab waveguide (and thereby the free propagation region 220) along the straight line. In other variations, the line is a curve, such that the plurality of output waveguide is connected to slab waveguide (and thereby the free propagation region 220) along the curve. In some variations, the line is selected such that it follows the average phase front of the beam of redirected light 260.

Similarly, the plurality of output waveguides 230a-230f may be orientated such that the output portion of each of the plurality of output waveguides 230a-230f is perpendicular to the average phase front of the beam of redirected light 260. In some variations, the output portions of each of the plurality of output waveguides 230a-230f are parallel to each other. In other variations, the output portions of each of the plurality of output waveguides 230a-230f are not parallel to each other. In still other variations, the output portions of each of a first subset of the output waveguides 230a-230f are parallel, while a second subset of the output waveguides 230a-230f are not parallel to the first subset of output waveguides 230a-230f.

While the optical splitter 200 is shown in FIG. 2 as having a single input waveguide 210 and six output waveguides 230a-230f, it should be appreciated that the same principles may be applied to other numbers of input waveguides and/or output waveguides. For example, the optical splitter 200 may be configured as a 1×N splitter with a single input waveguide and N output waveguides, where the number N may be selected based on the intended use of the optical splitter 200. In other instances, the optical splitter 200 may be configured with multiple input waveguides, such as an M×N splitter with M input waveguides and N output waveguides.

While the optical splitter 200 shown in FIG. 2 has a single continuous curved reflector, in other instances the optical splitters described herein may have multiple continuous curved reflectors. In generally, it may be desirable to both collimate the beam of input light and redistribute intensity within the beam of input light (e.g., to improve the uniformity of the intensity distribution). While a single continuous curved reflector may be configured to achieve one of these effects, multiple continuous curved reflectors may collectively achieve both effects.

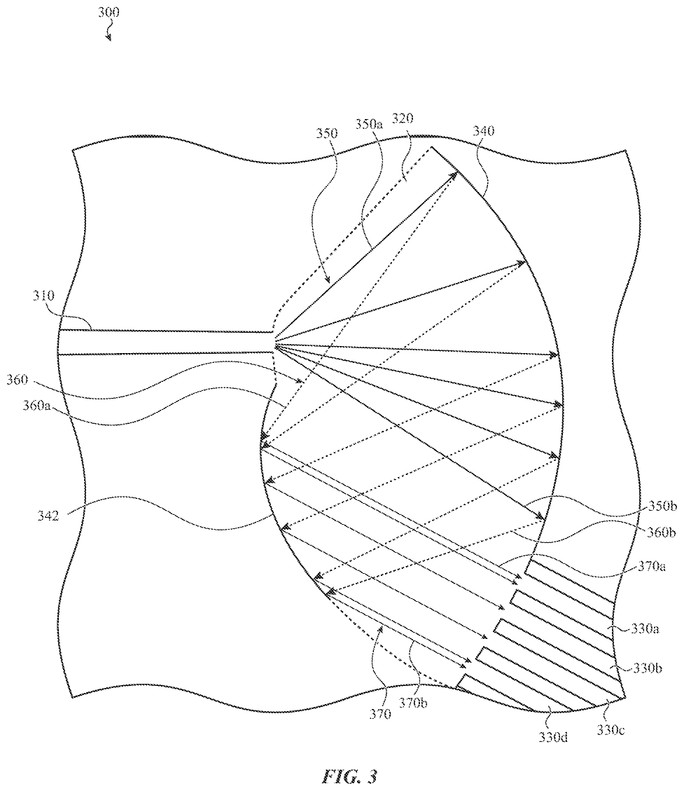

FIG. 3 depicts a top view of an optical splitter 300 as described herein that has multiple continuous curved reflectors. The optical splitter 300 includes an input waveguide 310, a free propagation region 320 of a slab waveguide, a first continuous curved reflector 340, a second continuous curved reflector 342, and a plurality of output waveguides 330a-330d. The input waveguide 310 is configured to introduce a beam of input light 350 into the free propagation region 320 that is received and redirected by the first continuous curved reflector 340 in a direction toward the second continuous curved reflector 342. The redirected light (depicted in FIG. 3 as a first beam of redirected light 360) is received and redirected by the second continuous curved reflector 342 in a direction toward the plurality of output waveguides 330a-330d. This redirected light (depicted in FIG. 3 as a second beam of redirected light 370) is received by the plurality of output waveguides 330a-330d such that each output waveguide receives a corresponding portion of the beam of input light. In this way, the optical splitter 300 may split input light received from the input waveguide 310 between the plurality of output waveguides 330a-330d.

Specifically, an input portion of the input waveguide 310 is connected to the free propagation region 320 to optically couple the input waveguide 310 to the free propagation region 320. The input portion of the input waveguide 310 terminates at a slab waveguide, where a portion of the slab waveguide acts as the free propagation region 320. The input waveguide 310 may receive light (e.g., from a light source unit as described herein) and emit a beam of input light 350 into the free propagation region 320. The beam of input light 350 is depicted in FIG. 3 by a set of rays between outermost rays 350a and 350b, though it should be appreciated that the beam of input light 350 fills the entire space between the outermost rays 350a and 350b. Similarly, the first and second beams of redirected light 360, 370 are depicted in FIG. 2 by sets of rays between corresponding outermost rays (i.e., outermost rays 360a and 360b for the first beam of redirected light 360 and outermost rays 370a and 370b for the second beam of redirected light 370), though it should be appreciated that these beam of redirected light fills the entire space between their outermost rays.

Light emitted from the input waveguide 310 will diffract as it enters the slab waveguide, such that the size of the beam of input light 350 increases as the beam traverses the free propagation region 320. In some instances, the input waveguide may be tapered or otherwise sized to improve the uniformity of the diffraction angle as a function of wavelength, such as described with respect to the optical splitter 200 of FIG. 2. The slab waveguide is sized such that the beam of input light 350 may freely propagate within the free propagation region 320 between the input waveguide 310 and the first continuous curved reflector 340, between the first continuous curved reflector 340 and the second continuous curved reflector 342 (i.e., as the first beam of redirected light 360), and between the second continuous curved reflector 342 and the plurality of output waveguides 330a-330d (i.e., as the second beam of redirected light 370). While dashed lines are used in FIG. 3 to illustrate certain boundaries of the free propagation region 320 (i.e., within a waveguide layer), it should be appreciated that the actual boundaries (if any) between the slab waveguide and surrounding cladding material (or air interfaces) may be positioned in any manner that will not impair the operation of the optical splitter 300.

The first continuous curved reflector 340 forms a first boundary of the slab waveguide and the second continuous curved reflector 342 forms a second boundary of the slab waveguide. The first continuous curved reflector 340 is sized and positioned to receive and redirect the beam of input light 350 toward the second continuous curved reflector 342 as the first beam of redirected light 360. Similarly, the second continuous curved reflector 342 is sized and positioned to receive and redirect the first beam of redirected light 360 toward the plurality of output waveguides 330a-330d as the second beam of redirected light 370. The first and second continuous curved reflectors 340, 342 may each function as a reflector to reflect the beam of input light, and may be formed in any manner as described above with respect to the continuous curved reflector 240 of FIG. 2.

In some variations, the first continuous curved reflector 340 has a profile that is decentered and/or tilted with respect to the input waveguide 310, such that the beam of input light 350 is directed away from the input waveguide 310 (and the first beam of redirected light 360 does not overlap with the input waveguide 310). Similarly, the second continuous curved reflector 342 has a profile that is decentered and/or tilted with respect to the first continuous curved reflector 340, such that the second beam of redirected light 370 is directed away from the first continuous curved reflector 340 (and the second beam of redirected light 370 does not overlap with first continuous curved reflector 340).

The first and second continuous curved reflectors 340, 342 may have any suitable profiles, such as those described above with respect to the continuous curved reflector 240 of FIG. 2. For example, in some variations one or both of the first and second continuous curved reflectors 340, 342 has an aspheric profile, such that the radius of curvature of the continuous curved reflector varies across the reflector. Collectively, the first and second continuous curved reflectors are positioned and shaped to impart a particular beam shape and intensity distribution of the portion of the beam of input light that reaches the plurality of output waveguides 330a-330d (i.e., the second beam of redirected light 370). For example, in some variations, the first and second continuous curved reflectors are positioned and shaped to collimate the redirected beam of input light (i.e., the second beam of redirected light 370) in a direction toward the plurality of output waveguides 330a-330d. Additionally or alternatively, the first and second continuous curved reflectors are positioned and shaped to increase the uniformity of the illumination in the collimated beam. In other words, the second beam of redirected light 370 has a more uniform intensity distribution at the plurality of output waveguides than the beam of input light 350 received by the first continuous curved reflector 340.

Accordingly, the increased uniformity of the intensity distribution in the second beam of redirected light 370 allows the plurality of output waveguides 330a-330d to be configured with a more uniform distribution of widths while still evenly splitting light between the output waveguides. Specifically, each output waveguide of the plurality of output waveguides 330a-330d includes an output portion that is connected to the slab waveguide (and thereby to the free propagation region 320) to optically couple the output waveguide to the free propagation region 320. In some instances, a width of the output portion of each of the plurality of output waveguides 330a-330d is substantially the same. Accordingly, in some instances the optical splitter 300 may be configured to evenly split light between a plurality of output waveguides having substantially the same width.

Additionally or alternatively, the plurality of output waveguides 330a-330d may be connected to the slab waveguide (and thereby the free propagation region 320) along a line, such as described with respect to the plurality of output waveguides 230a-230f of FIG. 2. This line may form a third boundary of the slab waveguide (and thereby form a third boundary of the free propagation region 320). The line may be a straight line or a curve as discussed herein. In instances where the second beam of redirected light 370 is collimated, the average phase front of the beam may follow a straight line. In these instances, the plurality of output waveguides 330a-330d may be connected to the slab waveguide along a straight that follows the average phase front of the second beam of redirected light 370.

Similarly, the plurality of output waveguides 330a-330d may be orientated such that the output portion of each of the plurality of output waveguides 330a-330d is perpendicular to the average phase front of the second beam of redirected light 370. In instances where the second beam of redirected light 370 is collimated, the output waveguides 330a-330d may be positioned such that the output portions of each of the plurality of output waveguides 330a-330d are parallel to each other. In other instances, some or all of the output portions of each of the plurality of output waveguides 330a-330d may not be parallel to each other. While the optical splitter 300 is shown in FIG. 3 as a 1×4 splitter, it should be appreciated that the optical splitter 300 may instead by configured as a 1×N or M×N splitter with any suitable values of N and M as may be desired given the needs of the optical splitter.

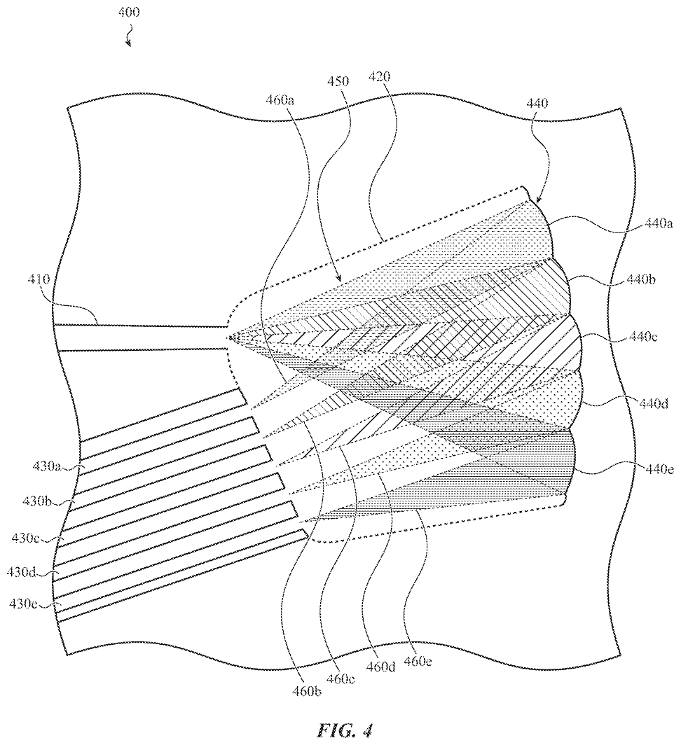

Some variations of the optical splitters described herein include a lensed reflector that includes a plurality of continuous curved segments. The lensed reflector is configured to divide a beam of input light into a plurality of output beams of light within a free propagation region, each of which may be coupled into a corresponding output waveguide. FIG. 4 illustrates an example of an optical splitter 400 with a lensed reflector 440. Specifically, the optical splitter 400 includes an input waveguide 410, a slab waveguide forming a free propagation region 420, the lensed reflector 440, and a plurality of output waveguides 430a-430e. The input waveguide 410 is configured to introduce a beam of input light 450 into the free propagation region 420 that is received and redirected by the lensed reflector 440. The lensed reflector 440 includes a plurality of continuous curved segments 440a-440e, each of which is configured to receive a corresponding portion of the beam of input light 450 and generates an output beam of light that is directed toward a corresponding output waveguide of the plurality of output waveguides 430a-430e. Accordingly, the lensed reflector 440 generates a plurality of output beams 460a-460e that respectively couple into the plurality of output waveguides 430a-430e, and the optical splitter 400 may thereby split input light received from the input waveguide 410 between the plurality of output waveguides 430a-430e. The beam of input light 450 is shown in FIG. 4 as having multiple portions (each represented with different markings) that represent the portions of the beam that will form each of the plurality of output beams 460a-460e, though it should be appreciated that the beam of input light 450 may be a single beam when emitted from the input waveguide 410.

Specifically, an input portion of the input waveguide 410 is connected to the free propagation region 420 to optically couple the input waveguide 410 to the free propagation region 420. The input portion of the input waveguide 410 terminates at a slab waveguide, where a portion of the slab waveguide acts as the free propagation region 420. The input waveguide 410 may receive light (e.g., from a light source unit as described herein) and emit a beam of input light 450 into the free propagation region 420.

Light emitted from the input waveguide 410 will diffract as it enters the slab waveguide, which results in the size of the beam of input light 450 increasing as the beam traverses the free propagation region 420. In some instances, the input waveguide may be tapered or otherwise sized to improve the uniformity of the diffraction angle as a function of wavelength, such as described with respect to the optical splitter 200 of FIG. 2. The slab waveguide is sized such that the beam of input light 450 may freely propagate within the free propagation region 420 between the input waveguide 410 and the lensed reflector 440, and the beams of output light 460a-460e may freely propagate in the free propagation region 420 between the lensed reflector 440 and the plurality of output waveguides 430a-430e. While dashed lines are used in FIG. 4 to illustrate certain boundaries of the free propagation region 420 (i.e., within a waveguide layer), it should be appreciated that the actual boundaries (if any) between the slab waveguide and surrounding cladding material (or air interfaces) may be positioned in any manner that will not impair the operation of the optical splitter 400.

The lensed reflector 440 forms a first boundary of the slab waveguide, and may be formed in any manner as described above with respect to the continuous curved reflector 240 of FIG. 2. Specifically, each of the continuous curved segments 440a-440e acts as a reflector to reflect and thereby redirect a corresponding portion of the beam of input light 450. The plurality of continuous curved segments 460a-460e are preferably configured to minimize spacing between immediately adjacent continuous curved segments 440a-440e. For example, in the variation shown in FIG. 4, the plurality of continuous curved segments 440a-440e is configured such that each pair of immediately adjacent continuous curved segments contact each other (in other words, the plurality of continuous curved segments 440a-440e is concatenated). In these instances, the entire beam of input light 450 is divided into the plurality of output beams 460a-460e, which may reduce losses associated with the operation of the optical splitter 400.

While a single continuous curved reflector may focus the entire beam of input light toward a single point, the lensed reflector 440 divides the beam of input light 450 into a plurality of beams of output light 460a-460e that are each focused toward a different corresponding point. Specifically, each continuous curved segment of the plurality of continuous curved segments 440a-440e is configured to focus its corresponding beam of output light toward a corresponding output waveguide of the plurality of output waveguides 430a-430e. For example, each of the plurality of continuous curved segments 440a-440e may focus its corresponding beam of output light toward a different output waveguide (e.g., the first continuous curved segment 440a focuses the first beam of output light 460a toward the first output waveguide 460a, the second continuous curved segment 440b focuses the second beam of output light 460b toward the second output waveguide 460b, etc.), such that each of the plurality of output waveguides 430a-430e receives light from a single continuous curved segment of the plurality of continuous curved segments 460a-460e. If desired, however, the optical splitter 400 may be configured such that a given output waveguide may receive light from two or more continuous curved segments.

Each of the plurality of continuous curved segments 440a-440e may be configured with any suitable profile (e.g., an ellipsoidal profile) that allows the curved segment to focus its corresponding beam of output light toward a corresponding output waveguide. In some instances, the plurality of continuous curved segments 440a-440e are sized such that the plurality of output beams 460a-460e each have substantially the same optical power. For purposes of this application, two or more beams of light are considered to have “substantially the same” optical power if the values of the optical power of these beams of light are within 20% of each other. In this way, the plurality of output waveguides 430a-430e may receive light having substantially the same optical power during operation of the optical splitter 400.

The plurality of output waveguides 430a-430e are positioned to receive the plurality of beams of output light 460a-460e from the lensed reflector 440. Specifically, each output waveguide of the plurality of output waveguides 430a-430e includes an output portion that is connected to the slab waveguide (and thereby to the free propagation region 420) to optically couple the output waveguide to the free propagation region 420. Each output waveguide of the plurality of output waveguides 430a-430e may be positioned such that the width of the corresponding beam of output light is narrower than a width output portion of the output waveguide when the beam of output light couples into the output waveguide. For example, in FIG. 4A the first beam of output light 460a is narrower than the first output waveguide 430a when it couples into the first output waveguide 430a, the second beam of output light 460b is narrower than the second output waveguide 430b when it couples into the second output waveguide 430b, and so on. In this way each output waveguide will receive the entire corresponding beam of output light, which may reduce optical losses that occurs when portions of a beam of light hit the cladding between adjacent output waveguide (such as occurs during the operation of the star coupler 100 of FIG. 1).

Because the lensed reflector 440 may be configured to direct the beams of output light in different directions, this may provide flexibility in the placement of the output waveguides 430a-430e. For example, the output waveguides 430a-430e connect to the slab waveguide along a straight line or a curved line as described above, or may be placed along an irregular path without impacting optical losses. Additionally, the plurality of output waveguides 430a-430e may be parallel as shown in FIG. 4. In other variations, some or all of output waveguides 430a-430e are not parallel to each other.

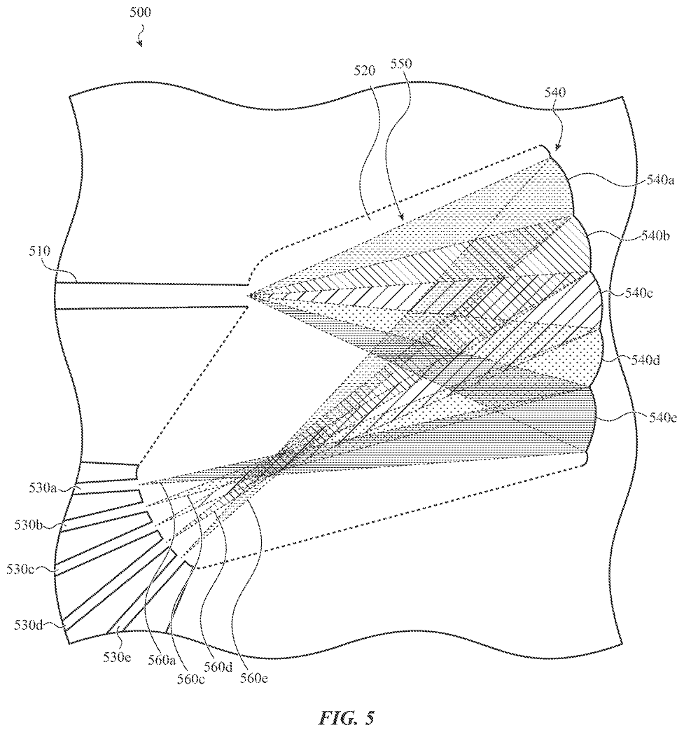

The optical splitter 400 shown in FIG. 4 as being configured such that the lensed reflector 440 divides the beam of input light 450 into the plurality of beams of output light 460a-460e that are directed such that the plurality of beams of output light 460a-460e do not intersect before reaching the plurality of output waveguides 430a-430e. In other instances, the optical splitter may be configured such that some or all of the beams output light 460a-460e cross each other before reaching the plurality of output waveguides 430a-430e. For example, FIG. 5 shows an example of an optical splitter 500 with an input waveguide 510, a slab waveguide defining a free propagation region 520, a lensed reflector 540 having a plurality of continuous curved segments 540a-540e, and a plurality of output waveguides 530a-530e. These components may be configured the same as their corresponding components from the optical splitter 400 of FIG. 4, except that the lensed reflector and the plurality of output waveguides 530a-530e are configured such, when a beam of input light 550 is emitted into the free propagation region 520 from the input waveguide 510, the lensed reflector 540 divides the beam of input light 550 into a plurality of beams of output light 560a-560e that cross each other before reaching the plurality of output waveguides 560a-560e. Additionally, in these instances it may be desirable for the output waveguides 560a-560e to not be parallel, which allows each of the output waveguides 560a-560e to be positioned perpendicular to the average phase front of its respective beam of output light. While the optical splitters shown in FIGS. 4 and 5 each include lensed reflectors that include five continuous curved segments and five output waveguides, the optical splitters may be configured to divide a beam of output light into any number of beams of output light as may be desired. Similarly, these beams of output light may be coupled into any number of output waveguides as may be desired.

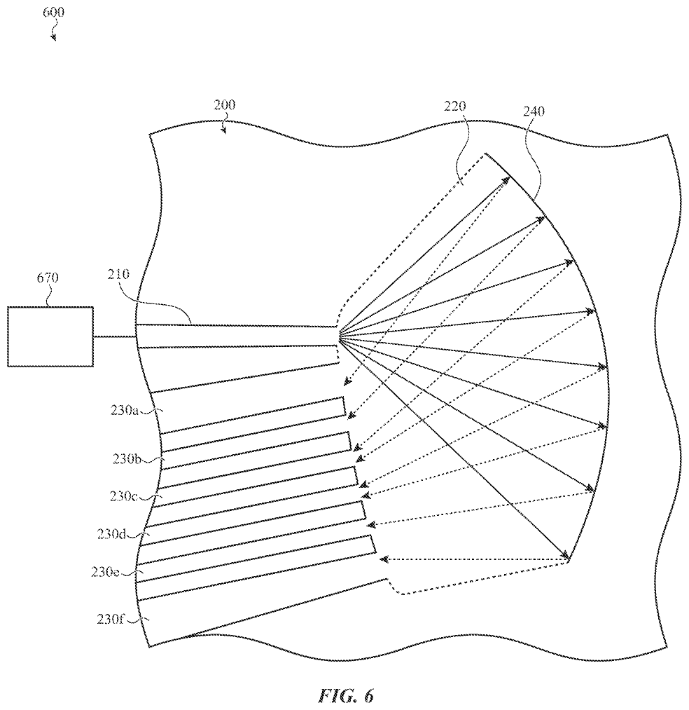

The optical splitters described herein may be incorporated in an optical system that includes a light source unit, such that the optical splitter is configured to split light received from the light source unit. For example, FIG. 6 depicts as an example of an optical system 600 that includes the optical splitter 200 of FIG. 2 and a light source unit 670 optically connected to the optical splitter 200. While the optical splitter 200 of FIG. 2 is included in FIG. 6 for the purpose of illustration, it should be appreciated that the optical system may alternatively (or additionally) include any other optical splitter as described herein that is optically coupled to the light source unit 670. The light source unit 670 may be configured to generate light at a single wavelength, or may be able to generate multiple different wavelengths across a predetermined wavelength range. The light source unit 670 includes a set of light sources (that may be a single light source or a plurality of different light sources), each of which is selectively operable to emit light at a corresponding set of wavelengths.

Each light source may be any component capable of generating light at one or more particular wavelengths, such as a light-emitting diode or a laser. A laser may include a semiconductor laser, such as a laser diode (e.g., a distributed Bragg reflector laser, a distributed feedback laser, an external cavity laser), a quantum cascade laser, or the like. A given light source may be single-frequency (fixed wavelength) or may be tunable to selectively generate one of multiple wavelengths (i.e., the light source may be controlled to output different wavelengths at different times). The set of light sources may include any suitable combination of light sources, and collectively may be operated to generate light at any of a plurality of different wavelengths.

To the extent the light source unit 670 is capable of generating multiple different wavelengths, the light source unit may be configured to generate different wavelengths of light simultaneously and/or sequentially. Some or all of the light sources of the light source unit 670 may be integrated into the photonic integrated circuits described herein. Additionally or alternatively, some or all of the light sources of the light source unit 670 may be positioned separately from the photonic integrated circuit and couple light into the photonic integrated circuit. The optical system 600 may include additional components (not shown) between the light sources of the light source unit and the output waveguides, such that the light may be altered before it reaches the output waveguide as input light.

During operation of the optical system 600, the light source unit 670 generates light such that at least a portion of the generated light is passed to an input waveguide 210 of the optical splitter 200. This light is split between a plurality of output waveguides as described herein. Depending on the operation of the optical system 600, the optical splitter 200 may split light across a range of wavelengths. For example, in some instances the optical splitter 200 may simultaneously receive and split light having multiple wavelengths of light. In other instances, the optical splitter 200 may sequentially receive and split light having different wavelengths. Accordingly, the optical splitters described herein may be operate across a range of wavelengths (though it should be appreciated that the optical splitter may not actually receive every wavelength between the longest and shortest wavelength of the range). For example, in some instances a target range of wavelengths may span at least 100 nm. In some of these variations, the target range of wavelengths may span at least 500 nm. In some of these variations, the target range of wavelengths may span at least 1000 nm.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. An optical splitter, comprising:
an input waveguide;
a free propagation region optically coupled to the input waveguide;
a continuous curved reflector positioned to receive and redirect a beam of input light introduced into the free propagation region from the input waveguide; and
a plurality of output waveguides optically coupled to the free propagation region, wherein:
each output waveguide of the plurality of output waveguides comprises an output portion connected to the free propagation region and positioned to receive a corresponding portion of the beam of input light redirected by the continuous curved reflector.

2. The optical splitter of claim 1, wherein a width of each output portion of each output waveguide of the plurality of output waveguides is substantially the same.

3. The optical splitter of claim 1, wherein:
the output portions of each of the plurality of output waveguides are parallel to each other.

4. The optical splitter of claim 1, wherein:
the continuous curved reflector has an intermediate portion positioned between a first peripheral portion and a second peripheral portion, wherein a radius of curvature of the continuous curved reflector is larger in the intermediate portion than in the first peripheral portion and the second peripheral portion.

5. The optical splitter of claim 1, wherein:
the output portions of each of the plurality of output waveguides are connected to the free propagation region along a straight line.

6. The optical splitter of claim 1, wherein:
the output portions of each of the plurality of output waveguides are connected to the free propagation region along a curve.

7. The optical splitter of claim 1, wherein:
the continuous curved reflector is decentered and/or tilted relative to the input waveguide, such that the continuous curved reflector is positioned to redirect the beam of input light away from the input waveguide.

8. The optical splitter of claim 1, wherein:
the continuous curved reflect is positioned to focus the beam of input light toward the plurality of output waveguides.

9. An optical splitter, comprising:
an input waveguide;
a slab waveguide optically coupled to the input waveguide;
a first continuous curved reflector positioned to form a first boundary of the slab waveguide and positioned to receive and redirect a beam of input light received from the input waveguide;
a second continuous curved reflector positioned to form a second boundary of the slab waveguide to receive the beam of input light redirected from the first continuous curved reflector; and
a plurality of output waveguides optically coupled to the slab waveguide, wherein:
each output waveguide of the plurality of output waveguides comprises an output portion connected to the slab waveguide along a third boundary of the slab waveguide and positioned to receive a corresponding portion of the beam of input light redirected by the continuous curved reflector.

10. The optical splitter of claim 9, wherein:
the first continuous curved reflector has an aspheric profile.

11. The optical splitter of claim 9, wherein:
the second continuous curved reflector has an aspheric profile.

12. The optical splitter of claim 9, wherein:
the first continuous curved reflector is decentered and/or tilted relative to the input waveguide, such that the first continuous curved reflector is positioned to redirect the beam of input light away from the input waveguide.

13. The optical splitter of claim 9 wherein:
the second continuous curved reflector is decentered and/or tilted relative to the first continuous curved reflector, such that the second continuous curved reflector is positioned to redirect the beam of input light away from the first continuous curved reflector.

14. The optical splitter of claim 9, wherein a width of each output portion of each output waveguide of the plurality of output waveguides is substantially the same.

15. The optical splitter of claim 9, wherein:
the first continuous curved reflector and the second continuous curved reflector are positioned and shaped to collimate the beam of input light in a direction toward the third boundary of the slab waveguide.

16. An optical splitter configured to split an input beam of light, comprising:
an input waveguide;
a free propagation region optically coupled to the input waveguide and positioned to receive the beam of input light from the input waveguide;
a lensed reflector positioned to receive the input beam of light introduced into the free propagation region and divide the input beam into a plurality of output beams of light; and
a plurality of output waveguides optically coupled to the free propagation region;
wherein:
the lensed reflector comprises a plurality of continuous curved segments; and
each continuous curved segment of the plurality of continuous curved segments is configured to:
receive a corresponding portion of the input beam of light; and
redirect the corresponding portion of the input beam of light to generate an output beam of light of the plurality of output beams of light, such that the continuous curved segment directs light to a corresponding output waveguide of the plurality of output waveguides.

17. The optical splitter of claim 16, wherein:
each output waveguide of the plurality of output waveguides comprises an output portion connected to the free propagation region; and
a width of each output portion of each output waveguide of the plurality of output waveguides is substantially the same

18. The optical splitter of claim 16, wherein:
the plurality of output waveguides is positioned such that the plurality of output beams of light cross within the free propagation region before reaching the plurality of output waveguides.

19. The optical splitter of claim 16, wherein:
each continuous curved segment of the plurality of continuous curved segments has an ellipsoidal shape.

20. The optical splitter of claim 16, wherein:
the lensed reflector is configured such that the output beam generated by each continuous curved segment of the plurality of continuous curved segments has substantially the same optical power.
